(19) United States
(12) Patent Application Publication
(10) Pub. No.: US 2017/0106469 A1
(43) Pub. Date: Apr. 20, 2017

(54) ULTRASONIC ADDITIVE MANUFACTURING ASSEMBLY AND METHOD

(71) Applicant: Hamilton Sundstrand Corporation, Charlotte, NC (US)

(72) Inventors: Eric Warren Karlen, Rockford, IL (US); William Louis Wentland, Rockford, IL (US)

(21) Appl. No.: 15/389,929

(22) Filed: Dec. 23, 2016

Related U.S. Application Data
(62) Division of application No. 14/295,916, filed on Jun. 4, 2014.

(51) Int. Cl. B23K 20/10; B23K 20/00; B29C 47/02; B23K 37/00; B29C 67/00; B33Y 10/00; B33Y 80/00

(52) U.S. Cl. CPC B23K 20/10; B33Y 10/00; B23K 20/002; B33Y 80/00; B23K 37/00; B29C 67/0092; B29C 47/02

(57) ABSTRACT

In one aspect, an assembly is provided. The assembly includes a substrate having a top surface and an inner wall, the inner wall defining a cavity, and at least one metal foil layer ultrasonically welded to the substrate top surface using an ultrasonic additive manufacturing process. The at least one metal foil layer extends across the cavity to define a passage, and the at least one metal foil layer is substantially planar and is parallel to the substrate top surface.

### CROSS REFERENCE TO RELATED APPLICATIONS

This application is a divisional of U.S. patent application Ser. No. 14/295,916 filed on Jun. 4, 2014, the contents of which are incorporated herein in their entirety by reference thereto.

### BACKGROUND OF THE INVENTION

This disclosure generally relates to structures manufactured using ultrasonic additive manufacturing, and more particularly, forming structures with channels or free spaces using ultrasonic additive manufacturing.

Ultrasonic additive manufacturing (UAM) is an additive manufacturing technique based on the ultrasonic welding of metal foils onto a substrate and computer numerically controlled (CNC) contour milling. UAM typically refers to a solid-state metal deposition process that enables build-up or net-shape fabrication of metal components. High-frequency ultrasonic vibrations are applied to the metal foil materials, which are held together under pressure, to create a solid-state weld. CNC contour milling may then be used to create the required shape for the given layer. The process is repeated until a solid component has been created or added to a component.

However, to successfully complete the UAM process, a large normal force is applied to the substrate and metal foil in order to form a metallurgical bond. When applying the metal foils to substrates or other foil layers having free spaces or cavities therein, the foil will sag into the empty space. This may change the geometry of the empty space, which may have a significant impact on fluid pressure drop and flow rates through the empty space. Further, subsequent metal foil layers applied to the sagging layer will not form a metallurgical bond at the sagging portion, which may prevent joining between multiple layers.

### BRIEF DESCRIPTION OF THE INVENTION

In one aspect, an assembly is provided. The assembly includes a substrate having a top surface and an inner wall, the inner wall defining a cavity, and at least one metal foil layer ultrasonically welded to the substrate top surface using an ultrasonic additive manufacturing process. The at least one metal foil layer extends across the cavity to define a passage, and the at least one metal foil layer is substantially planar and is parallel to the substrate top surface.

In another aspect, a method of manufacturing an assembly having a fluid passage is provided. The method includes providing a substrate having a top surface and an inner wall, the inner wall defining a cavity, providing an internal support, and positioning the internal support within the cavity. The method further includes orienting at least one metal foil layer on the substrate top surface, the at least one metal foil layer extending across the cavity, ultrasonically welding the at least one metal foil layer to the substrate top surface using an ultrasonic additive manufacturing process, and removing the inner support from the cavity to define the fluid passage.

In yet another aspect, an assembly having a fluid passage manufactured by a process is provided. The process includes the steps of providing a substrate having a top surface and an inner wall, the inner wall defining a cavity, providing an internal support, and positioning the internal support within the cavity. The process further includes orienting at least one metal foil layer on the substrate top surface, the at least one metal foil layer extending across the cavity. ultrasonically welding the at least one metal foil layer to the substrate top surface using an ultrasonic additive manufacturing process, and removing the inner support from the cavity to define the fluid passage.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of an enclosed channel formed by a UAM process without an internal support;

FIG. 2 is a cross-sectional view of an enclosed channel formed by a UAM process with an internal support;

FIG. 3 is a cross-sectional view of the enclosed channel shown in FIG. 2 after the internal support has been removed; and

FIG. 4 is a cross-sectional view of another enclosed channel formed by a UAM process with an internal support.

### DETAILED DESCRIPTION OF THE INVENTION

Described herein is a method and process of forming an object having free spaces or cavities therein using ultrasonic additive manufacturing (UAM). The method generally includes providing an internal support within an exposed cavity, enclosing the cavity with metal foil layers using the UAM process, and subsequently removing the internal support to form the enclosed cavity. The internal support facilitates preventing sagging of the metal foil layers into the enclosed cavity.

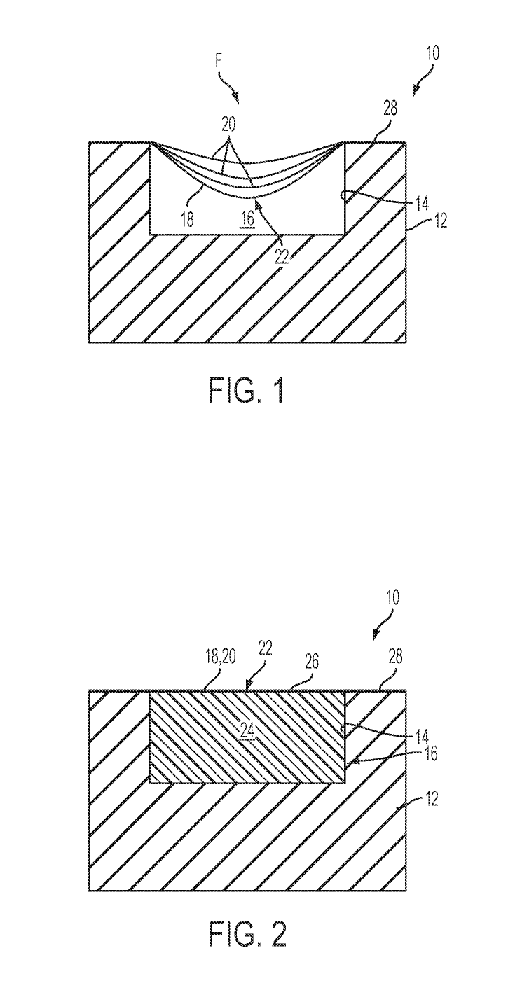

FIG. 1 illustrates an exemplary assembly 10 formed using the UAM process. In the exemplary embodiment, assembly 10 is a heat exchanger that generally includes a substrate 12 having an inner wall 14 defining a free-space or cavity 16. A metal foil layer 18 is oriented over cavity 16 and is welded to substrate 12 using the UAM process to enclose cavity 16. As such, this enclosed cavity or passage 16 may be utilized as a fluid passage for supplying a coolant therethrough to exchange thermal energy with a heat generating object (not shown). Additional metal foil layers 20 are subsequently be welded to layer 18 and/or other layers 20.

However, during the UAM process, a normal force ‘F’ is applied to each layer 18, 20. Without any support beneath portion 22 of layers 18, 20 extending across cavity 16, portion 22 of foil layers 18, 20 sags into cavity 16. As such, the sagging layers 18, 20 change the cross-sectional geometry of passage 16, which may impact the pressure drop and/or flow rate of the coolant supplied through passage 16. Further, sagging of foil layers 18, 20 inhibits coupling of those layers 18, 20 above cavity 16.

FIG. 2 illustrates assembly 10 with an internal support 24 positioned within cavity 16 such that a top surface 26 of internal support 24 is substantially coplanar with a top surface 28 of substrate 12. Metal foil layer 18 is oriented over internal support top surface 26 and substrate top surface 28 and is welded to substrate 12 using the UAM process. Additional metal foil layers 20 may be subsequently welded to layer 18 and/or other layers 20. In the exemplary embodiment, internal support 24 is a plastic material such as Acrylonitrile Butadiene styrene (ABS), Polyvinyl Alcohol (PVA), Poly(methyl methacrylate) (PMMA). However, internal support 24 may be fabricated from any suitable material that enables assembly 10 to function as described herein.

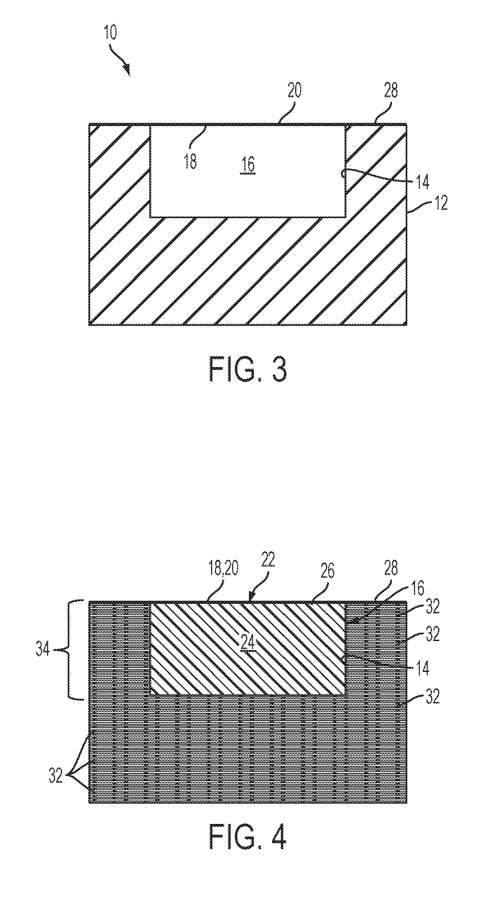

FIG. 3 illustrates assembly 10 with internal support 24 removed to form passage 16 after foil layers 18, 20 have been coupled to substrate 12. Internal support 24 may be removed from passage 16 by any suitable method. For example, internal support 24 may be melted and removed from passage 16. Alternatively, internal support 24 may be washed out of passage 16 by using a solvent (e.g., acetone) to dissolve or erode internal support 24. As shown, due to internal support 24, foil layers 18, 20 thus do not sag as they extend across passage 16, thereby providing passage 16 with a desired geometry. Accordingly, metal foil layers 18, 20 are substantially flat or planar and are oriented substantially parallel to substrate top surface 28.

A method of manufacturing assembly 10 includes providing substrate 12 and forming cavity 16 therein. Cavity 16 may be formed using any suitable process such as, for example, machining. Internal support 24 is subsequently positioned within cavity such that top surface 26 is substantially coplanar with substrate top surface 28. In the exemplary embodiment, internal support 24 is extruded or 3-D printed into cavity 16. However, internal support 24 may be provided by any suitable method.

Metal foil layer 18 is then positioned on substrate 12 and internal support 24 across cavity 16 and is subjected to the UAM process. Metal foil layer 18 may then undergo a contour milling process such as a computer numerically controlled (CNC) process to provide the desired shape of metal layer 18. Additional metal foil layers 20 may then be coupled to foil layer 18 and/or other foil layers 20 using the UAM process to form the desired structure over cavity 16. Foil layers 20 may also undergo a contour milling process.

Internal support 24 is subsequently removed from assembly 10 to form passage 16. In one example, internal support 24 is heated to a predetermined temperature to melt internal support 24 so it can be flowed from passage 16. In another example, a solvent (not shown) is supplied to passage 16 to break down internal support 24 so it can be washed from passage 16.

FIG. 4 illustrates an alternative assembly 30 that is similar to assembly 10 shown in FIG. 2, except substrate 12 is formed from a plurality of metal foil layers 32 using the UAM process. A portion 34 of metal foil layers 32 are contoured or machined to form cavity 16 using any suitable process (e.g., the CNC process).

A method of manufacturing assembly 30 includes welding metal foil layers 32 using the UAM process to form substrate 12. Individual foil layers 32 of portion 34 are machined to form cavity 16 within substrate 12. Cavity 16 may be formed using any suitable process such as, for example, CNC contour milling. Internal support 24 is subsequently positioned within cavity such that top surface 26 is substantially coplanar with substrate top surface 28. In the exemplary embodiment, internal support 24 is extruded or 3-D printed into cavity 16. However, internal support 24 may be provided by any suitable method.

Metal foil layer 18 is then positioned on substrate 12 and internal support 24 across cavity 16 and is subjected to the UAM process. Metal foil layer 18 may then undergo a contour milling process such as a computer numerically controlled (CNC) process to provide the desired shape of metal foil layer 18. Additional metal foil layers 20 may then be coupled to foil layer 18 and/or other foil layers 20 using the UAM process to form the desired structure over cavity 16. Foil layers 20 may also undergo a contour milling process.

Internal support 24 is subsequently removed from assembly 10 to form passage 16. In one example, internal support 24 is heated to a predetermined temperature to melt internal support 24 so it can be flowed from passage 16. In another example, a solvent (not shown) is supplied to passage 16 to break down internal support 24 so it can be washed from passage 16.

Described herein are systems and methods for forming assemblies with enclosed cavities or passages using UAM. A cavity is formed in a substrate and an internal support is positioned within the cavity. Metal foil layers are subsequently positioned across the cavity and coupled to the substrate using the UAM process. The internal support may then be removed from the assembly to form the enclosed passage. Accordingly, the internal support provides support to the metal foil layers extending across the cavity while they are coupled to the substrate. This may facilitate preventing sagging of the metal foil layers into the enclosed passage and forming metallurgical bonds between the portions of adjacent metal foil layers extending across the cavity.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of manufacturing an assembly having a fluid passage, the method comprising:
forming a substrate, by ultrasonic additive manufacturing, and machining the substrate to form a substrate top surface and a substrate inner wall defining a substrate cavity;
forming an internal plastic substrate support within the substrate cavity by extruding or 3-D printing the substrate support;
orienting at least one metal foil layer on the substrate top surface, the at least one metal foil layer extending across the substrate cavity; and
ultrasonically welding the at least one metal foil layer to the substrate top surface using the ultrasonic additive manufacturing process.

2. The method of claim 1, including removing the substrate support from the substrate cavity to define the fluid passage.

3. The method of claim 1, wherein the step of forming the substrate comprises:
ultrasonically welding together a plurality of metal foil layers using the ultrasonic additive manufacturing process to form the substrate having the substrate top surface; and
machining a portion of the metal foil layers of the plurality of metal foil layers to form the substrate with the substrate inner wall defining the substrate cavity.

4. The method of claim 1, wherein the step of forming the substrate internal support comprises a top surface substantially coplanar with the substrate top surface when the substrate support is formed within the cavity.

5. The method of claim 2, wherein the step of removing the substrate support comprises:
melting the substrate support; and
draining the melted substrate support from the substrate cavity to define the fluid passage.

6. The method of claim 2, wherein the step of removing the substrate support comprises:
applying a solvent to the substrate support to dissolve the substrate support; and
draining the solvent and dissolved substrate support from the cavity to define the fluid passage.
